(19) United States
(12) Patent Application Publication
(10) Pub. No.: US 2002/0100429 A1
(43) Pub. Date: Aug. 1, 2002

(54) Reptile and amphibian cage

(76) Inventor: Paul C. Wade, Vancouver, WA (US)

Correspondence Address: KURT M RYLANDER, 1014 FRANKLIN STREET, SUITE 206, VANCOUVER, WA, 98660, US

(21) Appl. No.: 09/772,125

(22) Filed: Jan. 29, 2001

(51) Int. Cl. A01K 1/03; A01K 31/06

(52) U.S. Cl. 119/452

(57) ABSTRACT

A novel cage for reptile and amphibian pets having a bottom wall, top wall, front wall, back wall, first and second side walls, wherein the walls are configured with selection from light-transmissive ventilating mesh screen, clear plastic, or clear glass plate with the requirement that at least three of the walls be configured with ventilating mesh screen, and wherein the bottom wall is removably connected to the cage, and wherein the top wall further has an access hatch, which can be configured with ventilating mesh screen, clear plastic, or clear glass plate, and the front has a door portion configured with light-transmissive ventilating mesh screen, clear plastic, or clear glass plate.

### FIELD OF THE INVENTION

The instant invention relates to animal cages and more particularly to cages for holding reptiles and amphibians.

### BACKGROUND

People keep reptiles and amphibians as pets. Examples of such kept pets include anoles, bearded dragons, water dragons, iguanas, chameleons, geckos, monitors, skinks, snakes, turtles, and tortoises, etc. Cages are used for housing these pets. Reptile and amphibian pets require cages with light and ventilation. Pet owners desire to have clear views of their pets when in the cages. Cages and pets require cleaning and maintenance. It is important when handling the pet, for cage cleaning or other purposes, to have alternate means of access to the pet. It is preferable that cage cleaning be easy and simple.

Known methods and articles for reptiles and cages exist. The following represents a list of known related art:

U.S. Pat. No. 5,794,567 issued to Itzhak, Aug. 18, 1998;

U.S. Pat. No. 5,134,969 issued to Mason et al, Aug. 4, 1992;

U.S Pat. No. 3,742,909 issued to Yellin, Jul. 3, 1973;

U.S. Pat. 6,112,700 issued to Brewer, Sep. 5, 2000; and

U.S. Pat. No. 5,842,439 issued to Selstad, Dec. 1, 1998.

The teachings of each of the above-listed citations (which does not itself incorporate essential material by reference) are herein incorporated by reference. None of the above inventions and patents, taken either singularly or in combination, is seen to describe the instant invention as claimed. Thus solving the aforementioned problems is desired.

Heretofore, application of methods and articles for caging reptiles and amphibians allowing observation and light from many different angles, and allowing ventilation from three or more sides, with access doors and hatches on top and on the front of the cage, with an easily removable bottom, and made from commercially available and common articles, has never been performed.

Therefore, it is highly desirable to create methods and articles meeting these needs and objects. Potential customers for the present invention include pet stores, chain stores, reptile and amphibian owners, zoos, researchers, and pet enthusiasts.

### OBJECTS AND SUMMARY

Accordingly, it is an object to provide novel articles and methods for solving the above-mentioned problems. In particular, it is an object to provide a cage for keeping reptiles and amphibians, and other animals, allowing ventilation, and viewing by the pet owner from many angles, ease of cleaning, and ease of access to the caged pet. It is a further object of the invention to provide improved elements and arrangements thereof for the purposes described which is inexpensive, dependable and fully effective in accomplishing its intended purposes. These and other objects of the present invention will become readily apparent upon further review of the following specification and drawings.

To achieve the objects and in accordance with the purpose of the invention, as embodied and broadly described herein, a reptile and amphibian cage is provided comprising a rectangular six sided cage with a removable bottom, two side walls, a top wall with a hatch assembly in the top wall, which can be provided with locking or latching means, a back wall, and a front wall with a door portion in the front wall, which can be provided with locking or latching means. The walls can all be provided with light-transmissive and air permeable mesh screen or, alternatively, select walls can be provided with light-transmissive clear plastic or glass plate, so long as at least three of the walls are mesh screen configured.

The accompanying drawings, which are incorporated in and constitute a part of this specification, illustrate one embodiment of the invention and, together with the description, serve to explain the principles of the invention.

The novel articles and methods provide a number of advantages. The present invention allows for ventilation to the pet, and airflow through the cage. The present invention allows for viewing of the caged pet from many different angles, front, back, top and sides. The present invention allows significant light into the cage, which aids in viewing the pet. The present invention allows for ease of cleaning and ease of access to the caged pet. The present invention can be made from readily available materials and is easy to manufacture.

Additional objects and advantages of the invention will be set forth in part in the description which follows, and in part will be obvious from the description, or may be learned by practice of the invention. The objects and advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a perspective view of an embodiment of the present invention.

FIG. 2 is a perspective view of an embodiment of the present invention from a different angle.

FIG. 3 is a perspective view of an embodiment of the present invention from yet another angle.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

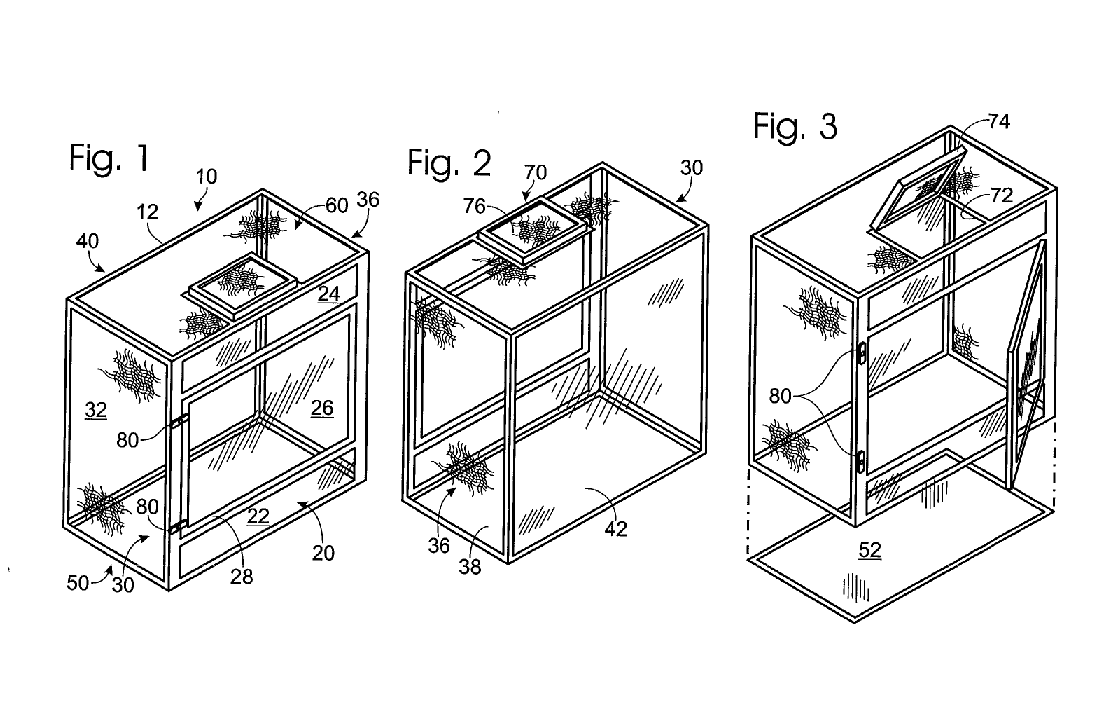

Turning now to a discussion of the present invention, a reptile and amphibian cage 10 is depicted in FIGS. 1, 2, and 3. A rigid frame 12 defines the edges of a six-sided rectangular cage 10 having a front wall 20, a first side wall 30, a second side wall 36, a back wall 40, a bottom wall 50, and a top wall 60. The frame is made of material such as wood, plastic, or metal.

As depicted in FIGS. 1, 2, 3, the first 30 and second 36 side walls each comprise a mesh screen 30 38 set within and connected to the edges of the first and second side walls, spanning the area defined by the edges of the first and second side walls, respectively.

The top wall 60 comprises mesh screen 62 and a hatch assembly 70 set within and connected to the edges of the top wall spanning the area defined by the edges of the top wall and the hatch assembly. The hatch assembly 70 allows access to the pet owner from the top to allow the pet to be added or removed from the cage. As depicted in FIG. 3, the hatch hinges upward from the hatch frame. The hatch assembly 70 includes hatch edges 74 set within a hatch frame 72. Mesh screen 76 is set within and connected to hatch edges 74, spanning the area defined by the hatch edges. Hatch frame 72 is connected to the top wall, and may also be connected to the rigid frame 12. Hatch edges 74 are connected by one or more hinges to hatch frame 72. Suitable conventional door hinges are well known in the art and numerous such hinges may be selected. The hatch can be provided with a latch or lock for securing the hatch.

The back wall 40 comprises a clear plate 42 set within and connected to the edges of the back wall and spanning the area defined by the edges of the side walls. In alternative embodiment, a mesh screen may be used instead of clear plate.

The front wall 20 comprises of a top portion 24, bottom portion 22, door frame 28, and door portion 26. The top, bottom, and door portions 24 22 26 of the front wall are clear plates, spanning the areas defined for the bottom, top, and door portions by the edges of the front wall and the door frame 28. The top portion clear plate 24 is set in and connected to the door frame 28 and edges of the rigid frame 12 defining the upper portion front wall. The bottom portion clear plate 22 is set in and connected to the door frame 28 and the edges of the rigid frame 12 defining the lower portion of the front wall. The door portion 26 is hingeably connected to the edges of the front wall. Door frame 28 is attached to and integral with rigid frame 12. The door portion 26 is in between the top portion and bottom portion of the front wall. As depicted in FIG. 3, the door portion 26 hinges outward from the front wall so that access to the cage can be gained from the front to allow the pet owner to add or remove reptiles or amphibians to the cage as desired. Suitable conventional door hinges are well known in the art and numerous such hinges may be selected. The front wall 20 can be provided with a latch or lock 80 to secure the door portion of the front wall. In alternative embodiment, mesh screen may be used instead of clear plate in the top portion, bottom portion, and door portion of the front wall.

The bottom wall 50 is a removable tray 52 made of clear plate within which the cage sits and from which the cage can be lifted out as depicted in FIG. 3. Removable tray can also be made of non transparent material including plastic, metal, or wood.

Mesh screens are light-transmissive and air permeable. Mesh screens may be aluminum wire mesh, vinyl coated fiberglass mesh, and other metallic meshes. The purpose of the mesh screen is to permit ventilation for the reptile or amphibian within. Having a ventilating mesh screen on more than one side permits air to flow through the cage.

Clear plates are clear plastic or glass plate, or other solid, transparent panels, whether of plastic, glass, or other materials.

In an alternative embodiment, clear plate may be used instead of mesh screen for the top and two side walls. Similarly, mesh screen may be used instead of the clear plate of the back and front walls. Configuration is limited to the requirement that at least three walls of the cage, top, bottom, front, back, and two sides, be mesh screen configured to permit the flow of ventilation through the cage.

Turning now to a description of the preferred embodiment, the cage illustratively has dimensions of 30″ in height, 18″ in depth and 24″ in width. The rigid frame 12 defining the edges of the six-sided rectangular cage are made of rolled aluminum. Likewise, the door frame 28 of the front wall 20 is made of rolled aluminum. The back wall plate 42 and the plates of the bottom portion 22, the top portion 24, and the door portion 26 of the front wall are clear tempered glass plate, having a thickness of ⅛″ inch. Plates, whether clear plastic or glass plate, are set and sealed in frames and edges with silicon sealant. Suitable silicon sealant is commercially available under the trade name silicon sealant from GE Silicones division of The General Electric Company. The first and second side walls and top wall are formed of aluminum wire mesh screen set in the rigid frame 12 with rubber spline. The door portion 26 in the front wall is hingeably attached to the rigid frame 12 with conventional continuous hinges, which, in the preferred embodiment, are 1 1/16″ aluminum continuous hinges. Other hinges may be used with equal applicability. The door portion of the front wall in the preferred embodiment is locked by flush mounted clips 80 mounted on the rigid frame 12 by pop riveting the clips. The clips can rotate at least ninety degrees, as depicted in FIGS. 1 and 3. The hatch assembly in the preferred embodiment is a preassembled wicket, including the hatch frame, hinges, and hatch edges and is set in the top wall by bolting to the rigid frame and attaching the mesh screen of the top wall by rubber spline. The hatch assembly of the preferred embodiment is commercially available, and in the preferred embodiment the entire assembly can be purchased as one part under the trade name Screen Wicket, part number 131-828, from Vanguard Plastics Ltd. of Surrey, British Columbia, Canada. Nylon mesh screen is set in and connected to the hatch edges with rubber spline, spanning the area defined by the hatch edges.

In another embodiment, the back wall, first and second side walls, top wall, and bottom, top, and door portions of the front wall are configured with light-transmissive and air permeable screen instead of clear plastic or glass plate. Numerous variations between mesh screen configured walls and plate configured walls can be selected, limiting the selections to the requirement that at least two of the front wall, top wall, back wall, and first and second side walls be mesh screen configured for ventilating air flow.

In operation, when the cage sits within the bottom, as shown in FIGS. 1 and 2, the reptile or amphibian can be placed within by opening the hatch in the top, or the door in the front. The animal within is thus securely caged. Mesh screens provide ventilation necessary for maintaining humidity and temperature regulation of the caged animal. Clear plates and light-transmissive mesh screen walls provide light for the caged animal, as well as viewing pleasure for the pet owner enthusiast. When cage and/or animal needs to be cleaned, animal can be secured by opening the hatch in the top or the door in the front to secure the animal, as depicted in FIG. 3. Cage is then lifted off of the bottom, as depicted in FIG. 3, and the bottom is cleaned. After cleaning the animal and the bottom, cage is placed back onto bottom, resting securely, and animal is reasserted into cage through hatch in the top or the door in the front.

The cage may be modified for use with many other species. Because of its transparency, the cage is ideal for animals that need to see each other. For those that do not, a simple barrier may be placed between cages. Although live plant material is not currently used in the research effort, the inventive cages are expected to accommodate live plants well. Thus, the inventive cages are ideal for housing of many animal species including lizards, small arboreal mammals, birds, and small arboreal non-human primates such as tamarinds or owl monkeys.

It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are also possible, their specific designs depending upon the particular application. As such, the scope of the invention should not be limited by the particular embodiments herein described but should be defined only by the appended claims and equivalents thereof.

The instant invention has been shown and described herein in what is considered to be the most practical and preferred embodiment. It is recognized, however, that departures may be made therefrom within the scope of the invention and that obvious modifications will occur to a person skilled in the art.

I claim:

1. A cage for housing reptile and amphibian pets, comprising:
a. a six-sided cage having a bottom wall, top wall, front wall, back wall, and first and second side walls, wherein said walls are configured with selection from the group consisting of light-transmissive, ventilating mesh screen, clear plastic, or clear glass plate, wherein at least three of the walls are configured with light-transmissive, ventilating mesh screen, and wherein the bottom wall is removably connected to the cage;
b. a hatch assembly connected to the top wall for accessing the interior of the cage from the top, wherein the hatch assembly is configured with selection from the group consisting of light-transmissive, ventilating mesh screen, clear plastic, or clear glass plate;
c. a door portion hingeably connected to the front wall, wherein the door portions is configured with selection from the group consisting of light-transmissive, ventilating mesh screen, clear plastic, and clear glass plate; and
d. wherein said top wall, said first and second side walls, said back wall, said front wall, and said removable bottom wall define a living space for an animal, the animal being removable through said top and through said front wall.

2. The cage of claim 1, wherein the top wall, bottom wall, first and second side walls, and front wall have edges made from the group consisting of wood, plastic, and metal.

3. The cage of claim 2, wherein said edges are made from rolled aluminum.

4. A cage for housing reptile and amphibian pets, comprising:
a. a rigid frame defining edges for a six-sided rectangular cage having a top wall, front wall, back wall, first side wall, second side wall, and a bottom wall;
b. a light-transmissive, ventilating mesh screen set within the edges of two or more of said framed top, front, back, first side and second side walls, wherein a clear plastic or glass plate is set within every wall which is not mesh screen configured;
c. a hatch assembly connected to said top wall for accessing the interior of the cage from the top;
d. a door portion hingeably connected to said edges of said front wall;
e. a bottom wall removably connected to said rigid frame; and
f. wherein said top wall, said first and second side walls, said back wall, said front wall, and said removable bottom wall, define a living space for an animal, the animal being removable through said top and through said front.

5. A cage for housing reptile and amphibian pets, comprising:
a. a rigid frame defining edges for a six-sided rectangular cage having a top wall, front wall, back wall, first side wall, second side wall, and a bottom wall;
b. a light-transmissive, ventilating mesh screen set within the edges of said top wall;
c. a hatch assembly connected to said top wall for accessing the interior of the cage from the top;
d. a light-transmissive, ventilating mesh screen set within the edges of said first side wall;
e. a light-transmissive, ventilating mesh screen set within the edges of said second side wall;
f. a light-transmissive, ventilating mesh screen back wall within said framed back;
g. a bottom wall removably attached to said rectangular frame;
h. wherein the front wall is comprised of a bottom portion of light-transmissive, ventilating mesh screen, a top portion of light-transmissive , ventilating mesh screen, and door portion of light-transmissive , ventilating mesh screen, and a door frame connected to said rigid frame, and wherein the door portion is hingeably connected to said rigid frame; and
i. wherein said top wall, said first and second side walls, said back wall, said front wall, and said removable bottom wall define a living space for an animal, the animal being removable through said top and through said front.

6. The cage of claim 5, wherein said front wall is comprised of a bottom portion of clear plate, a top portion of clear plate, and a clear plate door portion, wherein said door portion is hingeably connected to the edges defining said front wall, and wherein said back wall is a clear plate connected to said edges defining said back wall.

7. The cage of claims 1, 4, 5, or 6, wherein said mesh screen is chosen from the group consisting of metal wire mesh and vinyl coated fiberglass mesh.

8. The cage of claims 1, 4, 5, or 6, wherein said mesh screen is aluminum wire mesh.

9. The cage of claims 1, 4, 5, or 6, wherein said clear plate is chosen from the group consisting of clear plastic and clear glass plate.

10. The cage of claims 1, 4, 5, or 6, wherein said hinges are conventional continuous hinges.

11. The cage of claims 1, 4, 5, or 6, wherein said door portion is hingeably connected with conventional continuous hinges.

12. The cage of claims 1, 4, 5, or 6, wherein said door portion is hingeably connected with aluminum continuous hinges.

13. The cage of claims 1, 4, 5, or 6, further comprising:
a. a latch connected to said top wall for securing the hatch; and
b. a latch connected to the front wall for securing the door.

14. The cage of claims 4, 5, or 6, wherein said rigid frame is made from the group consisting of wood, plastic, and metal.

15. The cage of claims 4, 5, or 6, wherein said rigid frame is made from rolled aluminum.

16. The cage of claims 4, 5, or 6, wherein said door frame is made from the group consisting of wood, plastic, and metal.

17. The cage of claims 4, 5, or 6, wherein the door frame is made from rolled aluminum.

18. The cage of claim 4, 5, or 6, wherein said hatch assembly is configured with clear plate selected form the group consisting of clear plastic and clear glass.

19. The cage of claims 1, 4, 5, or 6, wherein said mesh screen is chosen from the group consisting of metal wire mesh and vinyl coated fiberglass mesh, wherein said clear plate is chosen from the group consisting of clear plastic and clear glass plate, wherein said door portion is hingeably connected with aluminum continuous hinges, wherein the frame is made from rolled aluminum, wherein the door frame is made from rolled aluminum, wherein said top hatch is framed plate glass chosen from the group consisting of clear plastic and clear glass, and wherein said cage further comprises:
a. a latch connected to said top wall for securing the hatch; and
b. a latch connected to the front wall for securing the door.
